(19) United States
(12) Patent Application Publication
(10) Pub. No.: US 2005/0068623 A1
(43) Pub. Date: Mar. 31, 2005

(54) Mirror frame with moisture-proof patterned side-frames for bathroom

(76) Inventor: Yong-Tie Jian, Tu-Cheng City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/675,022

(22) Filed: Sep. 30, 2003

(51) Int. Cl. G02B 1/00

(52) U.S. Cl. 359/512; 359/509

(57) ABSTRACT

A mirror frame with moisture-proof patterned side-frames for bathroom is introduced to protect patterns on the side-frames from being corroded by bathroom moisture so that the patterns can be better preserved. The side-frame of the mirror frame is designed as a hollow body having an airtight interior. A removal slender plate with patterns or painting is mounted into the airtight interior. By providing sealing-up to the airtight interior, the removal slender plate can then be isolated from the surrounding moisture and thus the patterns or painting on the removal slender plate can last permanently inside the transparent side-frame.

### BACKGROUND OF THE INVENTION

(1) Field of the Invention

The invention relates to a mirror frame, and more particularly to a mirror frame that has patterns sealed inside a moisture-proof side-frames of the mirror frame for bathroom.

(2) Description of the Prior Art

Taking a bath/shower is nothing but an ordinary work like having a meal. Though not-taking a bath/shower will not lead to death for sure, yet discomfort is definite an inevitable consequence. For bathing/showering, an isolated space, i.e. the bathroom, is needed to avoid spattering of water and also possible exposure of personal naked body. In the isolated space, a mirror, other than a water-supply system, is also required to help dressing. Generally, the mirror is provided with a frame. For the decorative purpose, the frame is usually dressed with carved patterns or painting. However, the moisture filling the bathroom during showering, especially in winter, is definite a negative to those patterns and painting. As a consequence, the patterns or painting will not last long but gradually eaten out by the moisture. It is the reason why the ordinary bathroom mirror frame is always so plain in appearance.

### SUMMARY OF THE INVENTION

Accordingly, it is a primary object of the present invention to provide a mirror frame with moisture-proof patterned side-frames which can protect the patterns permanently, either by printing or by painting, from moisture corrosion. A mirror frame of the present invention is made of transparent acrylics, having a flat slender sealed room isolated from the surroundings. Inside the flat slender room, a removable slender plate is contained. On the removable slender plate, a predetermined pattern, including either pictures or characters, is directly printed or painted, or indirectly adhered thereto. Then, the removable slender plate is moved into the sealed room at a side-frame of the mirror frame. For the mirror frame as well as its side-frames are transparent, the pattern can then be seen from outsides. Further, for the removable slender plate is sealed inside the airtight interior of the side-frame, the pattern will not be affected by the outside moisture and thus can last longer.

All the above objects are achieved by the mirror frame with moisture-proof patterned side-frames for bathroom described below.

### BRIEF DESCRIPTION OF THE DRAWINGS

The present invention will now be specified with reference to its preferred embodiment illustrated in the drawings, in which

FIG. 1-1, 1-2 and 1-3 are the front view, bottom view and left side view of a mirror frame for bathroom in accordance with the present invention, respectively;

FIG. 2-1, 2-2 and 2-3 are the enlarged front view, enlarged bottom view and enlarged planar left side view of a side-frame of the mirror frame in accordance with the present invention, respectively;

FIG. 3 is a cross-sectional view taken along line AA of FIG. 2-1;

FIG. 4 is a cross-sectional view taken along line BB of FIG. 2-1; and

FIG. 5 is an enlarged exploded perspective view of the side-frame in accordance with the present invention.

### DESCRIPTION OF THE PREFERRED EMBODIMENT

The invention disclosed herein is directed to a mirror frame with moisture-proof patterned side-frames for bathroom. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

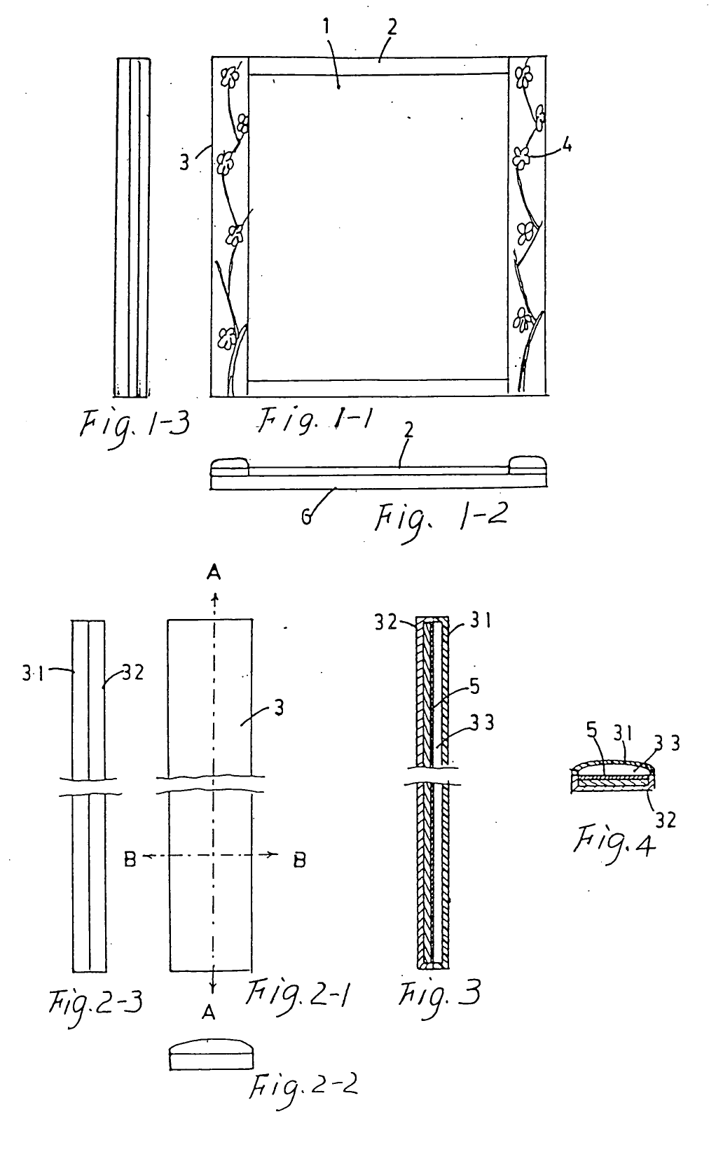

Referred now to FIGS. 1-1, 1-2 and 1-3, three schematic side views of a mirror frame in accordance with the present invention are shown. The mirror 1 is framed by two horizontal reinforced frames 2 and two side-frames 3. The side-frame 3 has a pattern 4 thereon. The pattern 4 can be formed as a decorative border, a couplet, or a poem.

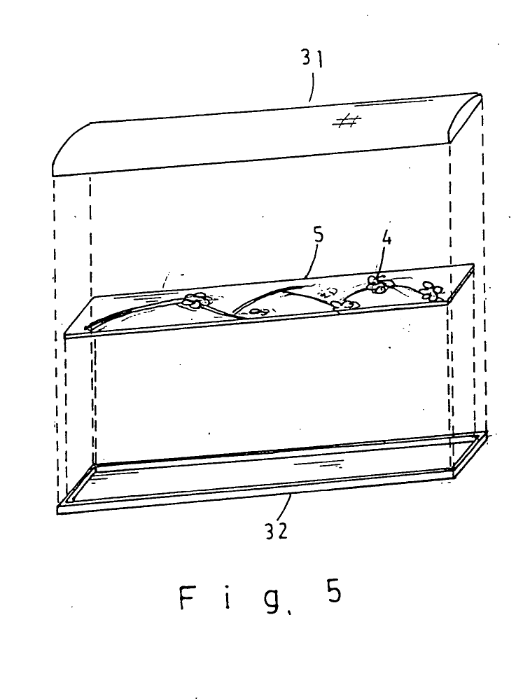

FIGS. 2-1, 2-2 and 2-3 are three enlarged side views of a side-frame. FIG. 3 and FIG. 4 are two cross-sectional views taken along line AA and line BB of FIG. 2-1, respectively. Also, FIG. 5 is an enlarged exploded perspective view of the side-frame in accordance with the present invention. As shown, the side-frame 3 includes an surface 31, a base 32 and a removable slender plate 5. The pop-out surface 31 is made of a transparent acrylic material. The removable slender plate 5 with a finished pattern is mounted on the dish-like base 32. The surface 31 is welded ultrasonically onto the base 32 to form a sealed room 33 for shielding the removable slender plate 5 thereinside. The sealed room 33 can be made as an airtight room that prevents the interior of the sealed room 33 from permeating of external moisture, so that the pattern on the removable slender plate 5 can last longer.

While the present invention has been particularly shown and described with reference to a preferred embodiment, it will be understood by those skilled in the art that various changes in form and detail may be without departing from the spirit and scope of the present invention.

1. A mirror frame with moisture-proof patterned side-frames for bathroom, wherein the side-frame is made of transparent acrylics, having a pop-out surface tightly welded onto a base and a bottom board by the edges thereof, which form thereinside a flat slender room between the bottom and the surface, and the bottom part of the room is welded onto a bottom lid so as to provide a completely sealed room.

2. The mirror frame with moisture-proof patterned side-frames for bathroom according to claim 1, wherein said sealed room contains thereinside a removable slender plate on which a predetermined pattern is either directly printed or painted, or indirectly adhered thereto.
